(19) United States
(12) Patent Application Publication
(10) Pub. No.: US 2025/0390041 A1
(43) Pub. Date: Dec. 25, 2025

(54) FIXING DEVICE AND IMAGE FORMING APPARATUS

(71) Applicant: KYOCERA Document Solutions Inc., Osaka (JP)

(72) Inventor: Yasuhito OKAJIMA, Osaka (JP)

(73) Assignee: KYOCERA Document Solutions Inc., Osaka (JP)

(21) Appl. No.: 19/228,266

(22) Filed: Jun. 4, 2025

(30) Foreign Application Priority Data
Jun. 20, 2024 (JP) 2024-099856

(51) Int. Cl. G03G 15/20

(52) U.S. Cl. CPC G03G 15/2053; G03G 15/2064; G03G 2215/2035

(57) ABSTRACT

A fixing device includes a fixing belt, a sliding member, a nip formation member and a pressurizing member. The sliding member is arranged adjacent to the inner side of the fixing belt in a radial direction, and the inner circumferential surface of the rotating fixing belt is in contact with the sliding member while sliding thereon. The nip formation member is arranged on the inner side of the fixing belt in the radial direction with the sliding member interposed between the nip formation member and the inner circumferential surface of the fixing belt. The nip formation member includes an uneven portion formed in a contact surface with the sliding member.

### INCORPORATION BY REFERENCE

This application is based upon and claims the benefit of priority from the corresponding Japanese Patent Application No. 2024-099856 (filed on Jun. 20, 2024), the entire contents of which are incorporated herein by reference.

### BACKGROUND

The present disclosure relates to a fixing device and an image forming apparatus.

In an image forming apparatus of an electrophotographic system such as a copying machine or a printer, a fixing device which adopts a thermal fixing system is widely used in order to fix an unfixed toner image formed on a sheet-shaped recording medium to the recording medium. The recording medium is heated and pressurized by passing through a fixing nip portion formed by contact between a heating member and a pressurizing member, and thus the unfixed toner image is fixed.

### SUMMARY

A fixing device according to an aspect of the present disclosure includes a fixing belt, a sliding member, a nip formation member, a support member and a pressurizing member, and inserts a recording medium into a fixing nip portion and heats and pressurizes the recording medium to fix a toner image formed on the recording medium to the recording medium. The fixing belt is seamless, is heated by a heating unit and is rotated along the conveyance direction of the recording medium. The sliding member is arranged adjacent to the inner side of the fixing belt in a radial direction, and the inner circumferential surface of the rotating fixing belt is in contact with the sliding member while sliding thereon. The nip formation member is arranged on the inner side of the fixing belt in the radial direction with the sliding member interposed between the nip formation member and the inner circumferential surface of the fixing belt. The support member is arranged on the inner side of the fixing belt in the radial direction to support the nip formation member. The pressurizing member is in contact with the nip formation member at a predetermined pressure with the sliding member and the fixing belt interposed to form the fixing nip portion between the pressurizing member and the fixing belt. The nip formation member includes an uneven portion formed in a contact surface with the sliding member.

### BRIEF DESCRIPTION OF THE DRAWINGS

FIG. 1 is a schematic cross-sectional front view of an image forming apparatus according to an embodiment of the present disclosure;

FIG. 2 is a cross-sectional front view of a fixing device in the image forming apparatus shown in FIG. 1;

FIG. 3 is a side view of a cut portion end surface of the fixing device in the image forming apparatus shown in FIG. 1;

FIG. 4 is a partial enlarged view of the fixing device shown in FIG. 2; and

FIG. 5 is a cross-sectional front view of a fixing device in a variation.

### DETAILED DESCRIPTION

An embodiment of the present disclosure will be described below with reference to drawings. The present disclosure is not limited to details described below.

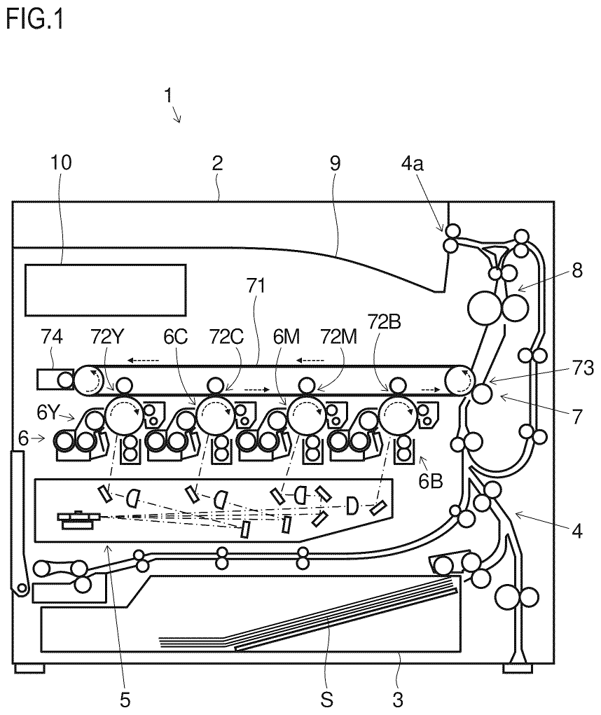

FIG. 1 is a schematic cross-sectional front view of an image forming apparatus 1 according to the embodiment. An example of the image forming apparatus 1 according to the present embodiment is a tandem type color printer which uses an intermediate transfer belt 71 to transfer a toner image to a sheet (recording medium) S. The image forming apparatus 1 may be, for example, a so-called multifunctional peripheral which has the functions of printing, scanning (image reading), fax transmission and the like.

As shown in FIG. 1, the image forming apparatus 1 includes a sheet supply unit 3, a sheet conveyance unit 4, an exposure unit 5, image formation units 6, a transfer unit 7, a fixing device 8, a sheet ejection unit 9 and a control unit 10 which are provided in an apparatus main body 2.

The sheet supply unit 3 is arranged in a bottom portion of the apparatus main body 2. The sheet supply unit 3 stores a plurality of sheets (recording media) S before printing, and feeds out the sheets S one by one during printing. The sheet conveyance unit 4 extends along a side wall of the apparatus main body 2 in an up/down direction. The sheet conveyance unit 4 conveys the sheet S fed from the sheet supply unit 3 to a secondary transfer unit 73 and the fixing unit 8, and further ejects the sheet S after fixing from a sheet ejection port 4a to the sheet ejection unit 9.

The exposure unit 5 is arranged above the sheet supply unit 3. The exposure unit 5 applies laser light controlled based on image data toward the image formation units 6. The image formation units 6 are arranged above the exposure unit 5 and below the intermediate transfer belt 71. The image formation units 6 include an image formation unit 6Y for yellow, an image formation unit 6C for cyan, an image formation unit 6M for magenta and an image formation unit 6B for black. These four image formation units 6 have the same basic configuration. Hence, in the following description, the identification symbols “Y”, “C”, “M” and “B” representing the colors may be omitted unless otherwise specified.

The image formation unit 6 includes a photosensitive drum which is supported rotatably in a predetermined direction (clockwise in FIG. 1). The image formation unit 6 further includes a charging unit, a development unit and a drum cleaning unit which are arranged around the photosensitive drum along the rotation direction thereof. A primary transfer unit 72 is arranged between the development unit and the drum cleaning unit.

In the photosensitive drum, a photosensitive layer is formed on an outer circumferential surface. The charging unit charges the outer circumferential surface of the photosensitive drum to a predetermined potential. The exposure unit 5 exposes the outer circumferential surface of the photosensitive drum charged by the charging unit to form an electrostatic latent image of an original image with attenuated charging on the outer circumferential surface of the photosensitive drum. The development unit supplies a toner to the electrostatic latent image on the outer circumferential surface of the photosensitive drum, and develops the electrostatic latent image to form a toner image. The four image formation units 6 form toner images of different colors. The drum cleaning unit performs cleaning by removing the toner and the like left on the outer circumferential surface of the photosensitive drum after the toner image is primarily transferred to the outer circumferential surface of the intermediate transfer belt 71. In this way, the image formation unit 6 forms an image (toner image) which is to be transferred to the sheet S later.

The transfer unit 7 includes the intermediate transfer belt 71, primary transfer units 72Y, 72C, 72M and 72B, the secondary transfer unit 73 and a belt cleaning unit 74. The intermediate transfer belt 71 is arranged above the four image formation units 6. The intermediate transfer belt 71 is a seamless intermediate transfer member which is supported rotatably in a predetermined direction (counterclockwise in FIG. 1) and onto which the toner images formed by the four image formation units 6 are superimposed and primarily transferred in a sequential manner. The four image formation units 6 are arranged in a so-called tandem system in which they are aligned from an upstream side to a downstream side in the rotation direction of the intermediate transfer belt 71.

The primary transfer units 72Y, 72C, 72M and 72B are arranged above the image formation units 6Y, 6C, 6M and 6B through the intermediate transfer belt 71. The secondary transfer unit 73 is arranged on the upstream side of the fixing device 8 in the sheet conveyance direction of the sheet conveyance unit 4 and on the downstream side of the four image formation units 6Y, 6C, 6M and 6B in the rotation direction of the intermediate transfer belt 71. The belt cleaning unit 74 is arranged on the downstream side of the secondary transfer unit 73 in the rotation direction of the intermediate transfer belt 71.

The primary transfer unit 32 transfers the toner image formed on the outer circumferential surface of the photosensitive drum to the intermediate transfer belt 71. In other words, the toner images are primarily transferred to the outer circumferential surface of the intermediate transfer belt 71 in the primary transfer units 72Y, 72C, 72M and 72B of the colors. Then, the toner images of the four image formation units 6 are continuously superimposed and transferred onto the intermediate transfer belt 71 together with the rotation of the intermediate transfer belt 71 at a predetermined timing, and thus a color toner image obtained by superimposing the toner images of the four colors of yellow, cyan, magenta and black is formed on the outer circumferential surface of the intermediate transfer belt 71.

The color toner image on the outer circumferential surface of the intermediate transfer belt 71 is transferred to the sheet S fed in synchronization by the sheet conveyance unit 4 in a secondary transfer nip portion formed in the secondary transfer unit 73. The belt cleaning unit 34 performs cleaning by removing adhered substances such as the toner left on the outer circumferential surface of the intermediate transfer belt 71 after the secondary transfer. In this way, the transfer unit 7 transfers (records) the toner image formed on the outer circumferential surface of the photosensitive drum to the sheet S.

The fixing device 8 is arranged above the secondary transfer unit 73. The fixing device 8 heats and pressurizes the sheet S to which the toner images have been transferred to fix the toner images to the sheet S.

The sheet ejection unit 9 is arranged above the transfer unit 7. The sheet S in which the toner images have been fixed and thus printing has been completed is conveyed to the sheet ejection unit 9. In the sheet ejection unit 9, the sheet (printed product) after printing is taken out from above.

The control unit 10 includes a CPU, an image processing unit, a storage unit and other electronic circuits and electronic components (which are not shown). The CPU controls, based on control programs and data stored in the storage unit, the operations of constituent elements provided in the image forming apparatus 1 to perform processing corresponding to the functions of the image forming apparatus 1. The sheet supply unit 3, the sheet conveyance unit 4, the exposure unit 5, the image formation units 6, the transfer unit 7 and the fixing device 8 individually receive commands from the control unit 10 to perform printing on the sheet S in conjunction with each other. The storage unit is, for example, a combination of nonvolatile storage devices (not shown) such as a program ROM (Read Only Memory) and a data ROM and volatile storage devices (not shown) such as a RAM (Random Access Memory).

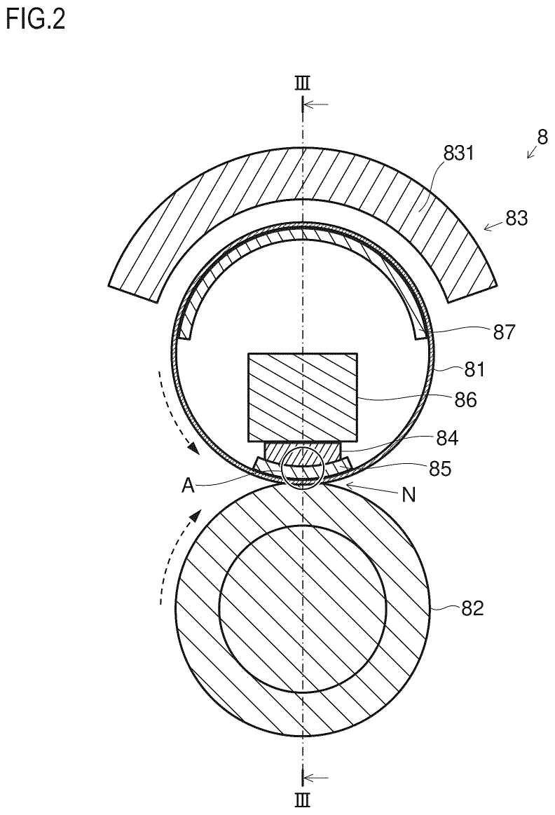

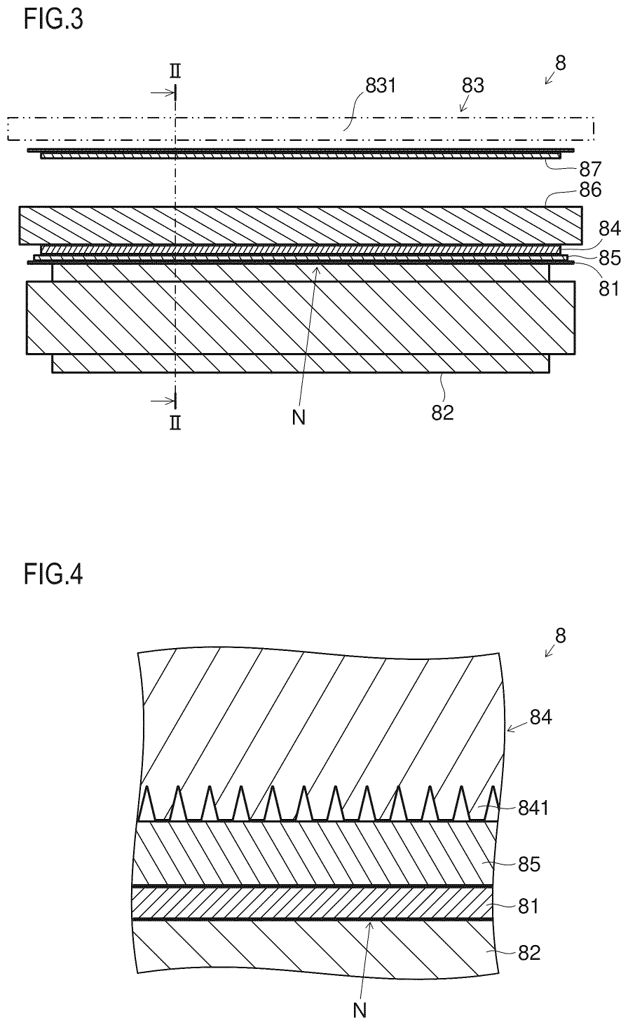

The configuration of the fixing device 8 in the embodiment will then be described in detail. FIG. 2 is a cross-sectional front view of the fixing device 8 in the image forming apparatus 1 shown in FIG. 1. FIG. 3 is a side view of a cut portion end surface of the fixing device 8 in the image forming apparatus 1 shown in FIG. 1.

FIGS. 2 and 3 show, for ease of description, a configuration in which a fixing belt 81 is arranged above a fixing nip portion N and a pressurizing roller (pressurizing member) 82 is arranged below the fixing nip portion N. The left side of FIG. 2 is the upstream side (the side of the transfer unit 7) in the sheet conveyance direction relative to the fixing device 8, and the right side is the downstream side (the side of the sheet ejection unit 9) in the sheet conveyance direction relative to the fixing device 8. FIG. 2 is a cross-sectional view taken along line II-II in FIG. 3, and FIG. 3 is a cut portion end surface view taken along line III-III in FIG. 2.

As shown in FIGS. 2 and 3, the fixing device 8 includes the fixing belt 81, the pressurizing roller 82, a heating unit 83, a nip formation member 84, a sliding member 85, a support member 86 and a belt guide 87.

The fixing belt 81 is supported by the housing portion of the fixing device 8 to be rotatable around a horizontal axial line. The fixing belt 81 is seamless, is formed in the shape of a cylinder having, for example, an outside diameter of 20 [mm] to 50 [mm] and is longer than the pressurizing roller 82 in a rotational axis line direction (a sheet width direction orthogonal to the sheet conveyance direction, the plane depth direction of FIG. 2 and the left/right lateral direction of FIG. 3). The fixing belt 81 can be rotated along the conveyance direction of the sheet S which is the recording medium.

The fixing belt 81 has a stacking structure in which an elastic layer and a mold release layer are provided on the outer circumferential side of a heat generation layer serving as a base layer. The heat generation layer is formed with, for example, a film made of a metal such as nickel having a thickness of 30 [μm] to 50 [μm] or a polyimide film containing metal powder of copper, silver, aluminum or the like and having a thickness of 50 [μm] to 100 [μm]. The elastic layer is formed of, for example, a silicone rubber or the like having a thickness of 100 [μm] to 500 [μm]. The mold release layer is formed of, for example, a fluorine-based resin such as PFA (tetrafluoroethylene-perfluoroalkylvinylether copolymer) having a thickness of 30 [μm] to 50 [μm]. The fixing belt 81 is heated by the heating unit 83.

The pressurizing roller 82 is supported by the housing portion of the fixing device 8 to be rotatable around a horizontal axial line. The pressurizing roller 82 is formed in the shape of a cylinder, and is shorter than the fixing belt 81 in a rotational axis line direction (the sheet width direction, the plane depth direction of FIG. 2 and the left/right lateral direction of FIG. 3).

A predetermined pressure is applied to the pressurizing roller 82 by a pressurizing mechanism (not shown) toward the side of the fixing belt 81. In this way, the pressurizing roller 82 is brought into contact with the outer circumferential surface of the fixing belt 81. In other words, the pressurizing roller 82 is brought into contact with the nip formation member 84 at the predetermined pressure with the sliding member 85 and the fixing belt 81 interposed. The fixing nip portion N is formed between the pressurizing roller 82 and the fixing belt 81.

The pressurizing roller 82 is coupled to, for example, a drive source (not shown) including a motor, and receives power from the motor to rotate clockwise in FIG. 2. The pressurizing roller 82 is in contact with the outer circumferential surface of the fixing belt 81 to provide a rotational drive force to the fixing belt 81. The fixing belt 81 is rotated counterclockwise in FIG. 2 according to the rotation of the pressurizing roller 82. The operation of the fixing belt 81 is controlled by the control unit 10.

The pressurizing roller 82 has a stacking structure in which an elastic layer and a mold release layer are provided on the outer circumferential side of a core metal. The core metal is formed of, for example, a metal such as iron or aluminum having a diameter of 20 [mm] to 25 [mm]. The elastic layer is formed of, for example, a silicone rubber or the like having a thickness of 3 [mm] to 8 [mm], and has an outside diameter of 30 [mm] to 35 [mm]. The mold release layer is formed of, for example, a fluorine-based resin such as PFA having a thickness of about 10 [μm] to 50 [μm].

The heating unit 83 is arranged opposite the outer circumferential surface of the fixing belt 81 with a predetermined distance left therebetween in a region on a side opposite to the side on which the pressurizing roller 82 is arranged relative to the fixing belt 81. The heating unit 83 extends longer than fixing belt 81 and the belt guide 87 along the rotational axis line direction (sheet width direction) of the fixing belt 81.

The heating unit 83 includes an excitation coil 831, an unillustrated holding member, a core and the like. The excitation coil 831 and the core are held by the holding member in a predetermined position relative to the fixing belt 81. The excitation coil 831 is formed with a litz wire obtained by bundling a plurality of conductive wires, and is wound to extend along the rotational axis line direction (sheet width direction) of the fixing belt 81. The excitation coil 831 is formed in the shape of an arc in the circumferential direction of the fixing belt 81 along the outer circumferential surface of the fixing belt 81.

The heating unit 83 heats the fixing belt 81 by electromagnetic induction. Specifically, the heating unit 83 heats the fixing belt 81 by heating the heat generation layer of the fixing belt 81 by induction heating.

The nip formation member 84 is arranged on the inner side of the fixing belt 81 in a radial direction with the sliding member 85 interposed between the nip formation member 84 and the inner circumferential surface of the fixing belt 81. The nip formation member 84 is arranged opposite the pressurizing roller 82 with the sliding member 85 and the fixing belt 81 interposed therebetween. The nip formation member 84 is in contact with the inner circumferential surface of the fixing belt 81 through the sliding member 85 to form the fixing nip portion N between the fixing belt 81 and the pressurizing roller 82.

The nip formation member 84 is substantially in the shape of a rectangular parallelepiped which has substantially the same length as the fixing belt 81 and extends along the rotational axis line direction (sheet width direction) of the fixing belt 81. The nip formation member 84 includes, for example, a base member which is formed of a metal such as aluminum or a heat-resistant resin such as a liquid crystal polymer. The nip formation member 84 may include an elastic layer which is formed of, for example, an elastomer, a silicone rubber or the like on the side of the base member opposite the fixing belt 81.

The sliding member 85 is arranged adjacent to the inner side of the fixing belt 81 in the radial direction in the fixing nip portion N. The sliding member 85 is interposed between the inner circumferential surface of the fixing belt 81 and the nip formation member 84. The inner circumferential surface of the rotating fixing belt 81 is in contact with the sliding member 85 while sliding thereon. The sliding member 85 is a sheet member which is formed of, for example, a fluorine-based resin such as PFA. The thickness of the sliding member 85 is, for example, about 200 [μm] to 400 [μm]. The sliding member 85 is intended to reduce a sliding load between the inner circumferential surface of the fixing belt 81 and the nip formation member 84.

The support member 86 is arranged on the inner side of the fixing belt 81 in the radial direction. The support member 86 extends longer than the fixing belt 81 along the rotational axis line direction (sheet width direction) of the fixing belt 81. The support member 86 is held by side plates (not shown) provided on both outer sides of the fixing belt 81 in the rotational axis line direction to secure strength capable of performing pressurization between the support member 86 and the pressurizing roller 82. The support member 86 is formed with, for example, a prism-shaped member, and supports the nip formation member 84 between the support member 86 and the inner circumferential surface of the fixing belt 81.

The belt guide 87 is arranged on the inner side of the fixing belt 81 in the radial direction opposite the heating unit 83 with the fixing belt 81 interposed therebetween. The belt guide 87 is in contact with the inner circumferential surface of the fixing belt 81 other than the fixing nip portion N to support the fixing belt 81 from the inner side in the radial direction. The belt guide 87 is formed with a metal sheet which has substantially the same length as the fixing belt 81 and extends along the rotational axis line direction (sheet width direction) of the fixing belt 81.

The belt guide 87 is formed of, for example, an elastic magnetic metal such as SUS430 having a thickness of 0.1 [mm] to 0.5 [mm]. The belt guide 87 plays a role in stabilizing the rotational orbit of the fixing belt 81 and in increasing the efficiency of heating the fixing belt 81 by absorbing a magnetic field penetrating the fixing belt 81 to generate heat.

In the configuration described above, the fixing device 8 inserts the sheet S into the fixing nip portion N between the fixing belt 81 and the pressurizing roller 82, and heats and pressurizes the sheet S to fix the toner images formed on the sheet S to the sheet S.

The detailed configuration of the fixing device 8 will then be described. FIG. 4 is a partial enlarged view of the fixing device 8 shown in FIG. 2. FIG. 4 is a partial enlarged view of the region of a circle A shown in FIG. 2.

The nip formation member 84 includes an uneven portion 841. The uneven portion 841 is a surface of the nip formation member 84 opposite the sliding member 85, and is formed in a contact surface of the nip formation member 84 with the sliding member 85. The uneven portion 841 is a region in which projections opposite the sliding member 85 and recesses are repeatedly provided relative to the radial direction of the fixing belt 81.

In the configuration described above, it is possible to increase frictional resistance between the sliding member 85 and the nip formation member 84, and to suppress a displacement of the sliding member 85 relative to the nip formation member 84. In other words, in the fixing nip portion N, the sliding member 85 can be fixed. In this way, it is possible to suppress a displacement (movement) of the sliding member 85 caused by the rotation of the fixing belt 81. Hence, it is possible to prevent the occurrence of failures such as damage to the sliding member 85 and poor rotation of the fixing belt 81.

In order to reduce a sliding load, a lubricant may be applied between the inner circumferential surface of the fixing belt 81 and the sliding member 85. In this case, there is a concern that the lubricant may enter an area between the sliding member 85 and the nip formation member 84 to reduce the frictional resistance between the sliding member 85 and the nip formation member 84. However, as in the present embodiment, the uneven portion 841 is formed in the nip formation member 84, and thus the lubricant is moved to the recesses of the uneven portion 841, with the result that it is possible to bring the nip formation member 84 into contact with the sliding member 85 in the projections of the uneven portion 841 without the intervention of the lubricant. In this way, it is possible to suppress a decrease in the frictional resistance between the sliding member 85 and the nip formation member 84.

The uneven portion 841 is preferably formed over the entire contact region with the sliding member 85 in the contact surface of the nip formation member 84 with the sliding member 85. In this configuration, the sliding member 85 is unlikely to be displaced (moved), and thus it is possible to enhance the effect of suppressing the displacement of the sliding member 85 relative to the nip formation member 84. In this way, it is possible to enhance the effect of suppressing the displacement (movement) of the sliding member 85 caused by the rotation of the fixing belt 81.

If the maximum height roughness Rz (JIS B 0601:2001) of the uneven portion 841 exceeds the thickness of the sliding member 85 in the radial direction, a pressure between the pressurizing roller 82 and the fixing belt 81 in the fixing nip portion N is excessively increased, and thus the image (toner images) on the sheet S may be adversely affected. When a pressure in the projections of the uneven portion 841 is excessively increased, there is a concern that the fixing belt 81 may be scratched and damaged.

Hence, the maximum height roughness Rz (JIS B 0601:2001) of the uneven portion 841 is preferably equal to or less than the thickness of the sliding member 85 in the radial direction. In this configuration, it is possible to increase the frictional resistance between the sliding member 85 and the nip formation member 84. In this way, it is possible to enhance the effect of suppressing the displacement of the sliding member 85 relative to the nip formation member 84. In other words, in the fixing nip portion N, the sliding member 85 can be fixed.

The recesses and projections of the uneven portion 841 should be a height difference (roughness) necessary to fix the sliding member 85 in the fixing nip portion N. If the height difference (roughness) in the recesses and projections of the uneven portion 841 is less than a predetermined value, it is likely that in the fixing nip portion N, the sliding member 85 cannot be fixed.

Hence, the maximum height roughness Rz (JIS B 0601:2001) of the uneven portion 841 is preferably equal to or greater than 20 [μm]. In this configuration, it is possible to increase the frictional resistance between the sliding member 85 and the nip formation member 84. In this way, it is possible to enhance the effect of suppressing the displacement of the sliding member 85 relative to the nip formation member 84. In other words, in the fixing nip portion N, the sliding member 85 can be fixed.

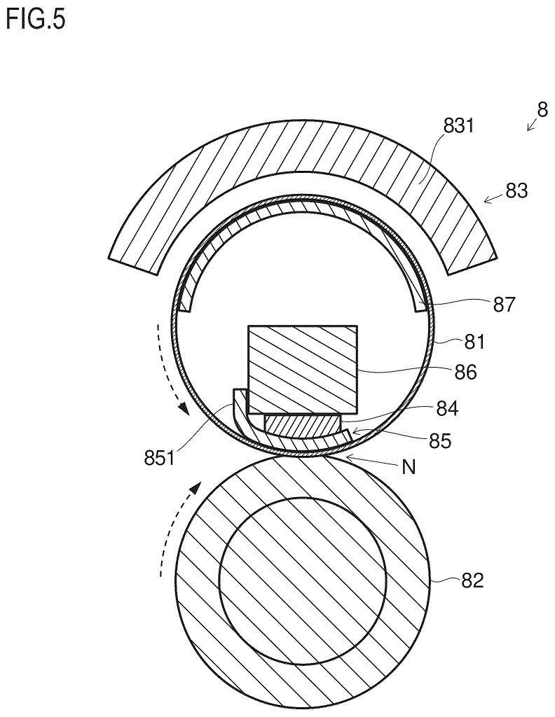

The configuration of a fixing device 8 in a variation will then be described. FIG. 5 is a cross-sectional front view of the fixing device 8 in the variation.

A sliding member 85 in the fixing device 8 in the variation includes a fixing portion 851. The fixing portion 851 is arranged on an upstream side in the rotation direction (counterclockwise in FIG. 5) of the fixing belt 81 relative to the fixing nip portion N. The fixing portion 851 is adjacent to the support member 86. The fixing portion 851 is fixed to the support member 86 using, for example, a fastening member (not shown) such as a screw. In other words, the sliding member 85 is fixed to the support member 86 on the upstream side in the rotation direction of the fixing belt 81 relative to the fixing nip portion N.

In the configuration described above, the sliding member 85 is fixed to the support member 86, and thus it is possible to suppress the displacement of the sliding member 85 relative to the nip formation member 84. In other words, in the fixing nip portion N, the sliding member 85 can be fixed. In this way, it is possible to suppress the displacement (movement) of the sliding member 85 caused by the rotation of the fixing belt 81. Hence, it is possible to prevent the occurrence of failures such as damage to the sliding member 85 and poor rotation of the fixing belt 81.

Although the embodiment of the present disclosure has been described above, the scope of the present disclosure is not limited to the embodiment, and various changes can be made without departing from the spirit of the disclosure.

For example, although in the embodiment described above, the image forming apparatus 1 is the so-called tandem type image forming apparatus for color printing which sequentially superimposes images of a plurality of colors to form an image, the image forming apparatus is not limited to this type of apparatus. The image forming apparatus may be an image forming apparatus for color printing other than the tandem type or an image forming apparatus for monochrome printing.

What is claimed is:

1. A fixing device comprising:
a seamless fixing belt that is heated by a heating unit and is rotated along a conveyance direction of a recording medium;
a sliding member
which is arranged adjacent to an inner side of the fixing belt in a radial direction and
with which an inner circumferential surface of the rotating fixing belt is in contact while sliding thereon;
a nip formation member that is arranged on the inner side of the fixing belt in the radial direction with the sliding member interposed between the nip formation member and the inner circumferential surface of the fixing belt; and
a support member that is arranged on the inner side of the fixing belt in the radial direction to support the nip formation member; and
a pressurizing member that is in contact with the nip formation member at a predetermined pressure with the sliding member and the fixing belt interposed to form a fixing nip portion between the pressurizing member and the fixing belt,
wherein in the fixing device that inserts the recording medium into the fixing nip portion and heats and pressurizes the recording medium to fix a toner image formed on the recording medium to the recording medium, the nip formation member includes an uneven portion formed in a contact surface with the sliding member.

2. The fixing device according to claim 1,
wherein a maximum height roughness Rz of the uneven portion is equal to or less than a thickness of the sliding member in the radial direction.

3. The fixing device according to claim 1,
wherein a maximum height roughness Rz of the uneven portion is equal to or greater than 20 [μm].

4. The fixing device according to claim 1,
wherein the uneven portion is formed over an entire contact region with the sliding member.

5. The fixing device according to claim 1,
wherein the sliding member is fixed to the support member on an upstream side in a rotation direction of the fixing belt relative to the fixing nip portion.

6. An image forming apparatus comprising:
an image formation unit that forms the toner image on the recording medium; and
the fixing device according to claim 1 that heats and pressurizes the recording medium on which the toner image has been formed by the image formation unit to fix the toner image to the recording medium.
